(19) United States
(12) Patent Application Publication
(10) Pub. No.: US 2023/0035104 A1
(43) Pub. Date: Feb. 2, 2023

(54) VERIFICATION METHOD, APPARATUS AND DEVICE, AND STORAGE MEDIUM

(71) Applicant: Alibaba Group Holding Limited, Grand Cayman (KY)

(72) Inventors: Wenchao CHENG, Hangzhou (CN); Zixi ZHOU, Hangzhou (CN); Guangxi LI, Hangzhou (CN)

(21) Appl. No.: 17/961,393

(22) Filed: Oct. 6, 2022

Related U.S. Application Data
(63) Continuation of application No. PCT/CN2021/085790, filed on Apr. 7, 2021.

(30) Foreign Application Priority Data
Apr. 8, 2020 (CN) 202010271236

(51) Int. Cl. G06F 21/35

(52) U.S. Cl. CPC G06F 21/35

(57) ABSTRACT

A method including: receiving verification information returned according to a verification request, wherein the verification information comprises a verification question corresponding to a verification target; displaying the verification question; determining a sliding distance according to the sliding indication and determining a verification answer according to the verification target corresponding to the sliding distance; and determining a verification result according to the verification question and the verification answer. According to the techniques of the present disclosure, a verification target such as a picture is gradually displayed with a sliding operation, which is not only difficult to obtain the answer through static analysis but also difficult to be done through a machine operation, thus improving verification accuracy.

### CROSS REFERENCE TO RELATED APPLICATIONS

This application claims priority to and is a continuation of PCT Patent Application No. PCT/CN2021/085790, filed on 7 Apr. 2021 and entitled “VERIFICATION METHOD, APPARATUS AND DEVICE, AND STORAGE MEDIUM,” which claims priority to Chinese Patent Application No. CN202010271236.4, filed on 8 Apr. 2020 and entitled “VERIFICATION METHOD, APPARATUS AND DEVICE, AND STORAGE MEDIUM,” which are incorporated herein by reference in their entirety.

### TECHNICAL FIELD

The present disclosure relates to the field of data technology, and, more particularly, to verification methods and apparatuses, electronic devices, and storage media.

### BACKGROUND

With the development of computer technology, more and more users use computers to perform various operations, such as browsing web pages, performing social interactions, and shopping. As users can perform more and more content online, data security is also increasingly important.

At present, users often need to verify many operations when logging into a website, shopping, and the like. There are some existing verification codes involving image recognition or text recognition. For example, multiple pictures are given to let users choose a correct picture, or a puzzle form is adopted to let users move a missing piece of the puzzle to the corresponding position to form a complete puzzle.

However, for this method, the result can often be determined through static analysis after a page is fully loaded, and then a user-simulated machine operation may be performed to click a corresponding position or slide to a corresponding end position, which makes the verification easy to be cracked and results in low accuracy.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “technique(s) or technical solution(s)” for instance, may refer to apparatus(s), system(s), method(s) and/or computer-readable instructions as permitted by the context above and throughout the present disclosure.

Embodiments of the present disclosure provide verification methods to improve verification accuracy.

Correspondingly, embodiments of the present disclosure further provide verification apparatuses, electronic devices, and storage media to ensure the implementation and application of the above-mentioned method.

In order to solve the above-described problem, an example embodiment of the present disclosure discloses a verification method, comprising: receiving verification information returned according to a verification request, wherein the verification information comprises a verification question corresponding to a verification target; displaying the verification question; determining a sliding distance according to the sliding indication and determining a verification answer according to the verification target corresponding to the sliding distance; and determining a verification result according to the verification question and the verification answer.

An example embodiment of the present disclosure also discloses a verification method, comprising: receiving a verification request; acquiring a verification target and a verification question and using the verification target and the verification question as verification information; sending the verification information to perform a verification operation according to the verification information and a sliding indication; and receiving a verification answer and determining a verification result according to the verification question and the verification answer.

An example embodiment of the present disclosure discloses a verification apparatus, comprising: a verification receiving module, configured to receive verification information returned according to a verification request, wherein the verification information comprises a verification question corresponding to a verification target; a display module, configured to display the verification question; an answer determination module, configured to determine a sliding distance according to a sliding indication and determine a verification answer according to the verification target corresponding to the sliding distance; and a result determination module, configured to determine a verification result according to the verification question and the verification answer.

An example embodiment of the present disclosure also discloses a verification apparatus, comprising: a request receiving module, configured to receive a verification request; a verification information determination module, configured to acquire a verification target and a verification question and use the verification target and the verification question as verification information; a verification information sending module, configured to send the verification information to perform a verification operation according to the verification information and a sliding indication; and a verification module, configured to receive a verification answer and determine a verification result according to the verification question and the verification answer.

An example embodiment of the present disclosure discloses an electronic device, comprising: a processor; and a memory having an executable code stored therein, wherein when the executable code is executed, the processor is caused to execute the method according to one or more of the embodiments of the present disclosure.

An example embodiment of the present disclosure discloses one or more machine-readable media having an executable code stored thereon, wherein when the executable code is executed, a processor is caused to execute the method according to one or more of the embodiments of the present disclosure.

Compared with the conventional techniques, the embodiments of the present disclosure have the following advantages:

According to the embodiments of the present disclosure, verification information returned according to a verification request is received, wherein the verification information comprises a verification question corresponding to a verification target. Then the verification question is displayed, and the verification target is gradually displayed with a sliding distance determined according to a sliding indication so that the displayed part in the verification target is determined according to the sliding distance. After the sliding is completed, a verification answer is determined based on the end position of the sliding and a verification result is determined according to the verification question and the verification answer. In this way, since a picture is gradually displayed with a sliding operation, it is not only difficult to obtain the answer through static analysis but also difficult to be done through a machine operation, thus improving verification accuracy.

### BRIEF DESCRIPTION OF DRAWINGS

To describe the technical solutions in the embodiments of the present disclosure more clearly, the following briefly describes the accompanying drawings needed for describing the embodiments. Apparently, the accompanying drawings in the following description show some instead of all embodiments of the present disclosure, and those of ordinary skill in the art may further derive other accompanying drawings from these accompanying drawings without creative efforts.

FIG. 1 is a schematic diagram of a verification-based data processing flow according to an embodiment of the present disclosure;

FIG. 2 is a schematic diagram of a display example of a verification page according to an embodiment of the present disclosure;

FIG. 3 is a schematic diagram of a display example of another verification page according to an embodiment of the present disclosure;

FIG. 4 is a schematic diagram of interactive processing according to a verification method embodiment of the present disclosure;

FIG. 5 is a structural block diagram of a verification apparatus embodiment of the present disclosure;

FIG. 6 is a structural block diagram of an example verification apparatus embodiment of the present disclosure; and

FIG. 7 is a schematic structural diagram of an apparatus provided by an embodiment of the present disclosure.

### DESCRIPTION OF EMBODIMENTS

In order to make the above-mentioned objectives, features, and advantages of the present disclosure clearer and easier to understand, the present disclosure will be further described in detail below with reference to the accompanying drawings and specific embodiments.

The embodiments of the present disclosure may be applied in security areas such as website security, data security, operation security, and transaction security, and may be used in various scenarios requiring verification such as registration verification, account login verification, data crawling verification, comment verification, transaction verification, and payment verification. The techniques of the present disclosure effectively prevent junk registration, malicious login, account theft, data crawling, malicious click farming, fake comments, fake transactions, fake seckilling, malicious cash-outs, stolen card payments, and other malicious behaviors.

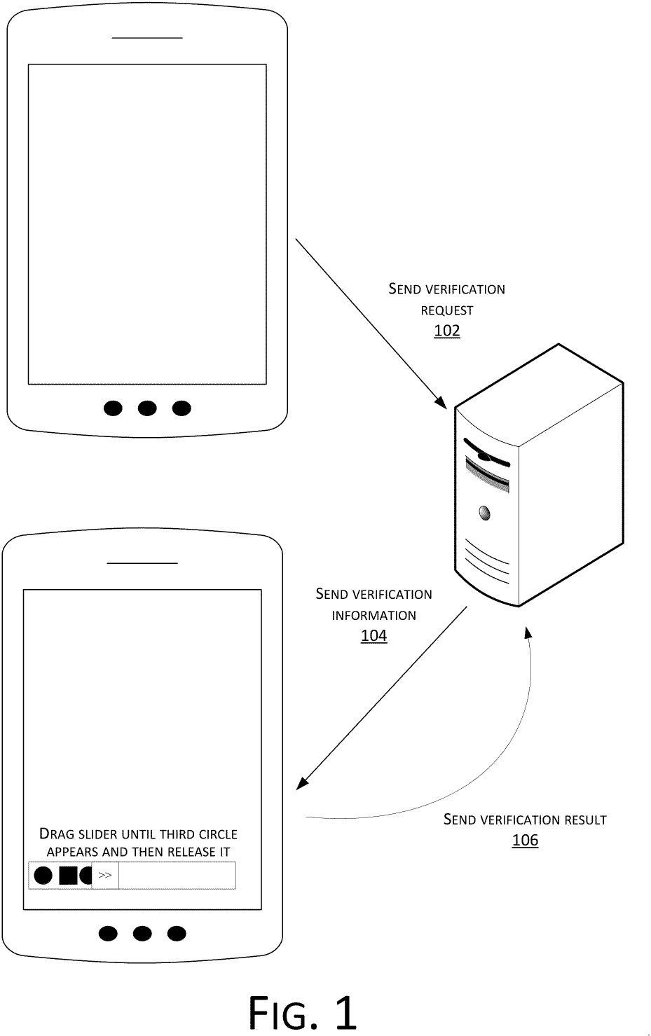

A verification-based data processing flow is shown in FIG. 1:

When using a device, for various scenarios requiring verification, a user can send a verification request to a server in Step 102. Here, the device may be a mobile device such as a mobile phone and a tablet computer, or may be a device such as a PC.

After receiving the verification request, the server can determine verification information according to the verification request, wherein the verification information comprises a verification question and a verification target. Then, in Step 104, the verification information is sent to the corresponding device. In the embodiment of the present disclosure, the verification information is composed of the verification question and the verification target, and the verification target comprises a verification answer to the verification question. For example, a picture is used as the verification target and the verification target may also be one or more of texts, numbers, and symbols so that various target objects can be verified.

After the device receives the verification information, it can display the corresponding verification question, as shown in FIG. 1, “drag the slider until the third circle appears, and then release it.” In the embodiment of the present disclosure, the verification question can be displayed on a verification page of the device, and a verification bar and the verification target can be set on the verification page, wherein the verification bar corresponds to the verification target.

In one display mode, a slider bar is displayed, and the verification target is hidden under the slider bar, wherein the slider bar comprises a slider. As shown in FIG. 1, the verification target is hidden under the slider bar, for example, a picture, text, number, symbol, or any other object is hidden under the slider bar, and corresponding parts of the verification target can be displayed at the positions passed by the slider so that the verification target can be gradually displayed as the slider moves to make the displayed verification target meet the verification with the verification question and obtain the corresponding verification answer.

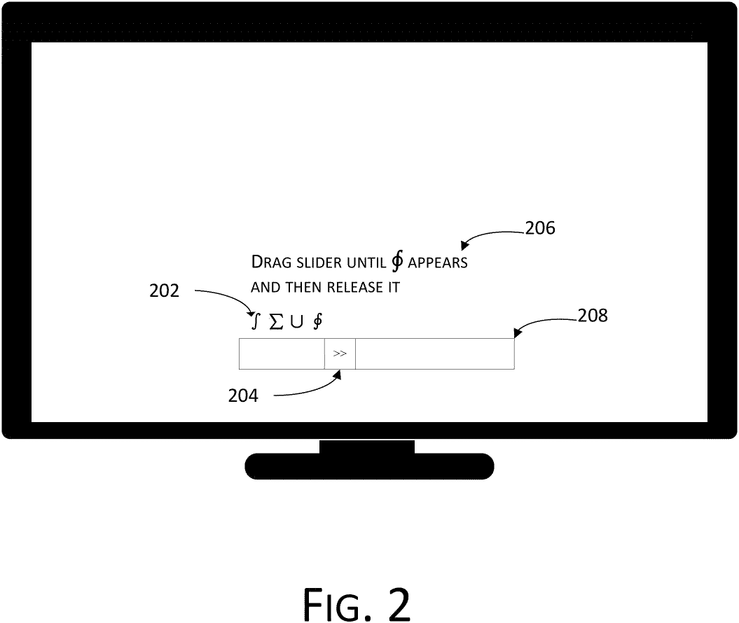

In another display mode, as shown in FIG. 2, the verification target and the slider bar are displayed separately. As shown in FIG. 2, the verification target is hidden by default, corresponding parts of the hidden verification target 202 are gradually displayed by dragging the slider 204 in response to the verification question 206 “Drag slider until ∮ appears and then release it”, a sliding distance of the slider on the slider bar 208 is determined, and corresponding sub-target information in the verification target is displayed according to the sliding distance. For example, when the slider 204 is slided from left to right, the symbols ∮ Σ U ∮ appear gradually.

In still another display mode, the verification target and the slide bar can be displayed, wherein the verification target corresponds to the slide bar, and content of the verification target can be displayed correspondingly by dragging the slider on the slider bar so that the slider can be dragged to a corresponding position based on the verification question to match the verification target to determine the verification answer.

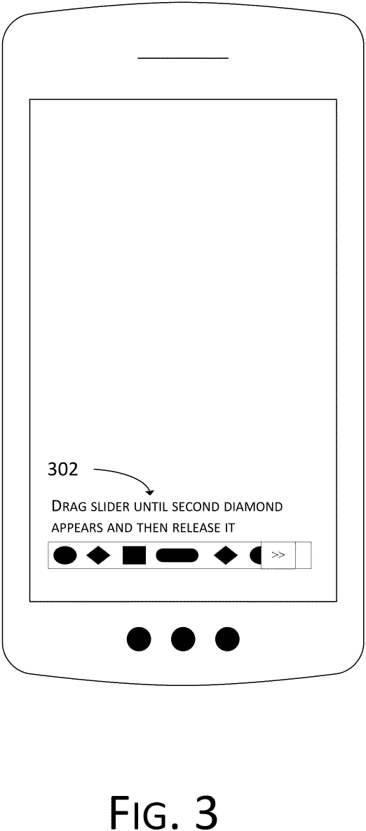

Thus, a sliding operation can be performed according to a sliding indication and a sliding distance can be determined. For example, the slider on the slider bar can be dragged according to the sliding indication to determine the sliding distance and parts of the verification target corresponding to the sliding distance, so as to determine the verification answer corresponding to the sliding operation and determine a verification result according to the verification answer and the verification question. Moreover, a condition for sliding beyond the verification question 302 is shown in FIG. 3, and reverse sliding may also be realized to obtain an accurate verification answer.

In some examples, the verification result corresponding to the verification answer and the verification question can be determined on the device, such as whether the verification is passed, and then the verification result is sent to the server in Step 106. The server can execute corresponding operations based on the verification result. If the verification is passed, operations following pass are executed and corresponding data is returned; and if the verification fails, it is not allowed to pass and a prompt message may be returned, or the verification information is re-sent to a user for verification.

Verification information returned according to a verification request is received, wherein the verification information comprises a verification question corresponding to a verification target; and then the verification question is displayed, and the verification target can be gradually displayed with a sliding distance determined according to a sliding indication so that the displayed part in the verification target can be determined according to the sliding distance, and after the sliding is completed, a verification answer is determined based on the end position of the sliding and a verification result is determined according to the verification question and the verification answer. In this way, since a picture is gradually displayed with a sliding operation, it is not only difficult to obtain the verification answer through static analysis but also difficult to be done through a machine operation, thus improving verification accuracy.

In the embodiment of the present disclosure, the verification target comprises one or more objects among pictures, texts, numbers, and symbols so that the same type of objects or different types of objects can be combined to form the verification target. In some examples, images of different types of targets such as fruits and vegetables can be used as objects to form the verification target and various combinations of texts, numbers, and symbols can be used to form a verification object, which can be applied in various verification scenarios.

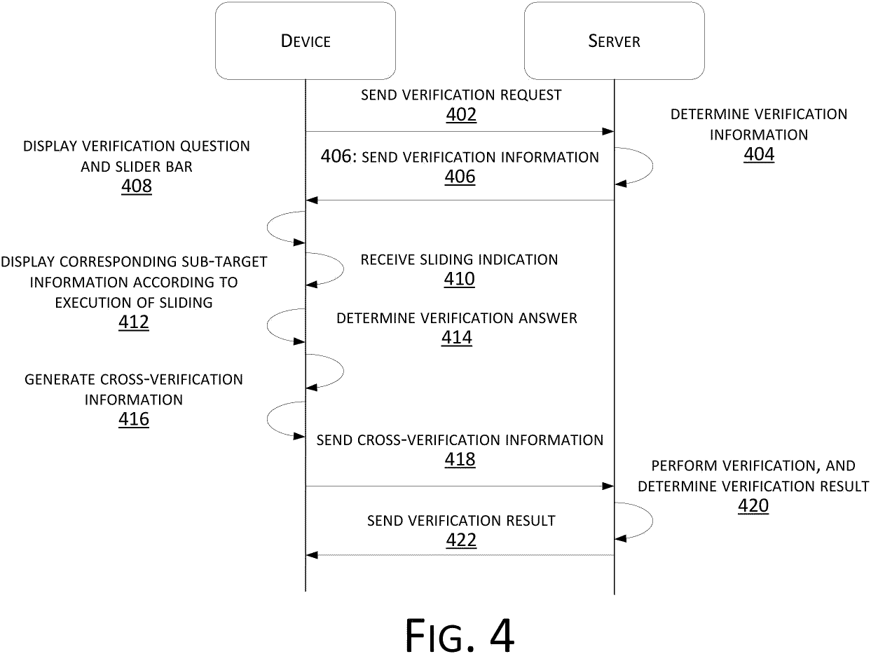

Referring to FIG. 4, a schematic diagram of interaction of a data processing method according to an embodiment of the present disclosure is shown.

Step 402: send a verification request.

When using a device, for various scenarios requiring verification, a user can send a verification request to a server. Here, the device may be a mobile device such as a mobile phone and a tablet computer, or may be a device such as a PC.

Step 404: determine verification information.

After receiving the verification request, the server can determine verification information according to the verification request. Here, a verification target and a verification question can be acquired, and then the verification target and the verification question are used as the verification information.

In some embodiments, acquiring the verification target and the verification question comprises at least one of the following: determining the verification question, determining a target object according to content of the verification question, and determining the verification target according to the target object; and acquiring the target object, determining the verification target according to the target object, and determining the verification question according to content of the verification target.

In one example, the verification question can be acquired first, and then the content of the verification question, such as the things expressed by the verification question, can be determined. The content can be used as a target, and then one or more target objects corresponding to the content can be inquired in an object library to determine the verification target according to the target objects. For example, if some pictures contain a target, a corresponding number of target objects can be acquired according to the verification question to form the verification information.

In another example, the target object can be acquired first, according to which the verification target can be determined, and then corresponding content of the target object can be determined, such as things described therein, and next the verification question can be determined according to the content. Here, the target object can comprise one or more targets, and the verification question and the like can be determined based on the number of targets in the target object, which may be determined based on the actual needs.

In some embodiments, the verification question can comprise an interference object to improve verification accuracy. Therefore, the interference object can also be acquired from the object library, and then the interference object and the target object can be combined to generate the verification target. If a picture containing a circle is used as the target object, a picture containing a square, triangle, diamond, or any other pattern can be used as the interference object, and the object containing the correct content and the object containing the interference item can be combined as the verification target. Here, when a target object comprises multiple targets, the target object can be segmented and an interference object can be inserted to be combined as the verification target, or an interference object can be inserted among multiple target objects to be combined as the verification target.

In the embodiment of the present disclosure, in order to improve verification accuracy, the verification target may not be transmitted first, but identification information corresponding to the verification target may be carried in the verification information, so as to acquire the verification target according to the identification information. Here, the target object and the interference object can be combined to obtain the verification target and used as sub-target information of the verification target, a target identifier of each piece of the sub-target information can be determined according to the combination relationship, and multiple target identifiers corresponding to the verification question and the verification target can be formed into the verification information. In other examples, the verification target may also be segmented to determine corresponding sub-target information; and target identifiers corresponding to the sub-target information are determined, and the target identifiers and the verification question are used as the verification information.

Step 406: send the verification information.

After determining the verification information, the server can send the verification information to the device.

Step 408: display a verification question and a slider bar.

Step 410: receive a sliding indication.

Step 412: display corresponding sub-target information according to execution of sliding.

After the verification information is acquired, a verification question can be displayed, which is used to give a prompt of sliding verification and a condition required for verification. Accordingly, a slider bar can also be displayed on the page, on which a slider is set and can be dragged to give a sliding indication.

In the embodiment of the present disclosure, the slider bar and the verification target are displayed correspondingly so that the sub-target information of the displayed verification target can be determined based on the sliding distance of the slider, and the sub-target information contained in the verification target can be gradually displayed with the execution of sliding.

In some embodiments, the verification target is composed of a target object and an interference object as the sub-target information. In other examples, the verification target can also be segmented into multiple pieces of sub-target information. Each piece of sub-target information can correspond to a target identifier. When the target identifier is displayed on the device, the sub-target information can be acquired and displayed according to the target identifier. Therefore, on the device, the sub-target information corresponding to the target identifier can be acquired and displayed as the slider moves, or as the sliding distance changes. In some example embodiments, the target identifiers may not have a sequential relation, so the sequence of the target identifiers can be randomly arranged on the device to randomly display each sub-picture according to the change of the sliding. Of course, the sub-target information may have a display order which is carried in the verification information and returned to the device. The device executes display based on the display order or determines the display order of respective pictures by calculating the target identifiers, which is not limited in the embodiment of the present disclosure.

In the embodiment of the present disclosure, the corresponding sub-target information in the verification target can be displayed according to the sliding distance. With the execution of sliding, the greater the sliding distance is, the more the displayed corresponding sub-target information in the verification target is. The sliding distance can be determined according to the start position and the current position of the sliding indication. Therefore, if the sliding indication is executed with the slider bar and the slider, the distance moved through by the slider can be determined as the sliding distance, and the position passed by the moving slider is the position where the sliding distance changes, so as to display the corresponding sub-target information.

Here, for the display of the slider bar and the verification target, in some examples, the slider bar can be displayed, and the verification target is hidden under the slider bar, wherein the slider bar comprises a slider. The statement that the verification target is hidden under the slider can be understood as covering the sub-target information in the verification target through the slider bar, or hiding a part of the sub-target information in the verification target under the slider and displaying it as the slider moves. The sub-target information can be requested from the server as the slider moves.

For the case that the sub-target information is requested as the slider moves, the device comprises the target identifiers of the sub-target information, and the verification information can also comprise a part of the sub-target information so that the part of the sub-target information can be initially hidden under the slider bar and the slider, and is displayed at the position passed by the slider as the slider moves. When the moving distance of the slider reaches the length corresponding to the part of the sub-target information or the last N piece of the sub-target information in the part of the sub-target information, such as the last one and two pieces of the sub-target information, it can be requested from the server to download other parts of the sub-target information in the verification target according to the target identifiers. Here, the sub-target information can be downloaded piece by piece or set by set, or the remaining parts of the sub-target information can be downloaded, which may be determined based on actual needs. The downloaded other parts of the sub-target information are hidden under the slider bar and the slider, and gradually displayed as the slider moves. Therefore, a next piece of the sub-target information to be displayed can be downloaded according to the sliding indication.

In other examples, the verification target and the slider bar can be separated, for example, the verification target is displayed on the page after downloading, and the slider is in a corresponding position over or under the verification target so that the movement of the slider can correspond to the content in the verification target, and the slider can reach the verification target according to the sliding distance to determine the verification answer.

In an example in which a verification target and a slide bar can be displayed separately, the slide bar can also be displayed, and the verification target corresponding to the slide bar is hidden, wherein the slide bar comprises a slider. The verification target is hidden in a position over or under the slider bar, and corresponding sub-target information in the verification target is displayed as the slider moves. The moving distance of the slider on the slider bar can be determined, and the corresponding sub-target information in the verification target can be displayed according to the moving distance. This example is similar to the above-described example of hiding the verification target under the slider bar, in which the sub-target information in the verification target can also be requested from the server as the slider moves, so that at least a next piece of the sub-target information to be displayed is kept under the slider.

Therefore, in the embodiment of the present disclosure, the corresponding sub-target information in the verification target can be displayed according to the sliding distance, which comprises displaying a slider bar and hiding the verification target under the slider bar, wherein the slider bar comprises a slider; or displaying a slider bar and hiding the verification target corresponding to the slider bar. Accordingly, a position on the slider bar passed by the slider is determined, and the corresponding sub-target information in the verification target is displayed at the position; or a moving distance of the slider on the slider bar is determined, and the corresponding sub-target information in the verification target is displayed according to the moving distance.

Further, the verification target can be displayed, and a slider bar can be displayed correspondingly, wherein the slider bar comprises a slider.

The verification information further comprises target identifiers of the sub-target information in the verification target; and the method further comprises downloading the sub-target information according to the target identifiers and forming the verification target according to the sub-target information.

The verification information further comprises target identifiers of the sub-target information and a part of the sub-target information in the verification target; and the method further comprises downloading, according to the sliding indication, a next piece of the sub-target information to be displayed.

Step 414: determine a verification answer.

In the embodiment of the present disclosure, a verification answer can be determined according to the verification target corresponding to the sliding distance, and the part of the verification target displayed by sliding can be determined according to the sliding distance to obtain the corresponding verification answer, for example, the content of the verification target displayed by sliding is used as the verification answer. Here, the user can release the slider and stop sliding when he/she believes that a condition corresponding to the verification question is met, and the corresponding position finally reached by the sliding (such as the position where the slider is released) can be determined as the end position of the sliding, based on which the displayed part of the verification target can be determined, such as the displayed sub-target information.

In an example embodiment, determining a verification answer according to the verification target corresponding to the sliding distance comprises determining, according to the sliding distance, a sequence set of the target identifiers of the sub-target information in the verification target; and determining, according to the sequence set of the target identifiers, the verification answer. The sub-target information displayed based on the execution of sliding can be determined to obtain the target identifiers of the sub-target information, and the sequence set of the target identifiers can be formed according to the display order, which can be determined as the verification answer.

Step 416: generate cross-verification information.

Step 418: send the cross-verification information.

Cross-verification information is formed with the verification question and the verification answer, and then the cross-verification information is sent. In other examples, the verification question can correspond to information such as a question identifier, so the question identifier and the verification answer are also formed into the cross-verification information. In other examples, the server can record the verification question corresponding to the device, so the verification question may not be carried in the cross-verification information but is determined by the server.

In some other example embodiments, sliding information corresponding to the sliding indication is acquired, wherein the sliding information comprises at least one of the following: stress information and speed information; and the sliding information is added into the cross-verification information. In order to prevent machine operations which simulate user behaviors, for a sliding operation performed by touching a touch screen device, a human-machine check can also be performed based on the cross-verification information. Therefore, the corresponding sliding information during the process of executing the sliding indication, such as stress information and speed information of the sliding operation, can be acquired based on sensors. The speed information can be average speed, speed change information, or the like, so as to facilitate the server to perform the human-machine check more accurately. In addition, the operating environment information of the device can also be carried for a more accurate check. For example, during the dragging process, the user may drag beyond the requirement of the verification question, and then reverse dragging can be performed to realize release when the condition corresponding to the verification question is met. Changes in sliding speed and stress information may appear in the corresponding sliding information, so that such information can be collected to check human and machine operations.

Step 420: perform a check according to the cross-verification information, and determine a result of the check.

Here, the cross-verification information can be received, which comprises the verification question and the verification answer; and it is checked whether the verification answer meets a condition corresponding to the verification question: if the condition corresponding to the verification question is met, the verification result of a pass is generated; and if the condition corresponding to the verification question is not met, the verification result of a failure is generated.

After the cross-verification information is received, it is checked whether the verification answer meets the condition corresponding to the verification question, such as whether the verification target contains the target with enough data required by the verification question, whether the sliding stops in the required position, and whether it exceeds the content required by the verification question. If the condition corresponding to the verification question is met, the verification result of a pass is generated; and if the condition corresponding to the verification question is not met, the verification result of a failure is generated.

In an example embodiment, the cross-verification information further comprises sliding information, wherein the sliding information comprises at least one of the following: stress information and speed information; and after it is determined that the condition corresponding to the verification question is met, the method further comprises: determining, according to the sliding information, whether the corresponding sliding indication is a machine operation. After it is confirmed that the verification is passed, a check of human and machine operations can also be performed to prevent machine operations which simulate user behaviors and ensure the accuracy of verification. Therefore, sliding information can be acquired. For example, for electronic devices with touch screens such as mobile phones and tablet computers, it can be checked whether there is stress information and whether there is a certain rule in the change of stress information, so as to determine whether it is a user operation or a machine operation. If it is a user operation, the stress may become bigger and bigger rather than keeps a uniform growth; and if it is a machine operation, the verification result of a failure is determined. Some PCs also have a touch screen. For such devices, it is possible to distinguish between sliding by touch and dragging by clicking a mouse, so as to collect and report stress information for the sliding by touch. In some other examples, the sliding speed corresponding to the sliding indication can be acquired, which can be speed change or other information, so that it can be determined whether the change is uniform. The sliding process operated by the user is usually dynamic, for example, the sliding speed may get slower, or repeated sliding may appear later, so that it can be determined whether it is a user operation or a machine operation based on the change of the sliding.

Therefore, it is possible to comprehensively analyze and determine the user’s trajectory, answer to a question, operating environment, and other information to conclude whether it is a machine operation and complete the verification of human and machine operations.

Step 422: send the verification result.

The server can send the verification result to the device so that the device can perform corresponding operations according to the verification result. If the verification is passed, it will perform operations following pass and request the server to return corresponding page data; and if the verification fails, it is not allowed to pass and a prompt message may be generated, or the verification information is re-sent to the user for verification.

On the basis of the above-described embodiment, the embodiments of the present disclosure can be applied to various scenarios such as registration verification, account login verification, data crawling verification, comment verification, transaction verification, and payment verification. They can effectively prevent junk registration, malicious login, account theft, data crawling, malicious click farming, fake comments, fake transactions, fake seckilling, malicious cash-outs, stolen card payments, and other malicious behaviors.

Taking the registration verification scenario as an example, the user can click verification on a registration page, thereby triggering the sending of a verification request to a server, and then verification information returned according to the verification request is received, wherein the verification information comprises a verification question corresponding to a verification target; the verification question is displayed on a registration verification page; a sliding distance is determined according to a sliding indication and a verification answer is determined according to the verification target corresponding to the sliding distance; a verification result determined according to the verification question and the verification answer is uploaded; and the verification result returned from the server is received. If the verification is passed, the next step of the registration can be performed; and if the verification fails, the verification can be performed again.

Taking the account login verification scenario as an example, the user can enter login information such as an account and password on a registration page and then click a login control to log in and trigger the sending of a verification request to a server if verification is required, and then verification information returned according to the verification request is received, wherein the verification information comprises a verification question corresponding to a verification target; the verification question is displayed on an account login verification page; a sliding distance is determined according to a sliding indication and a verification answer is determined according to the verification target corresponding to the sliding distance; a verification result determined according to the verification question and the verification answer is uploaded; and the verification result returned from the server is received. If the verification is passed, normal login can be performed to display a corresponding page; and if the verification fails, the verification can be performed again.

Taking the data crawling verification scenario as an example, the user can perform data crawling operations such as search and query on various pages, thereby triggering the sending of a verification request for the crawling to the server, and then verification information returned according to the verification request is received, wherein the verification information comprises a verification question corresponding to a verification target; the verification question is displayed on a search or query verification page; a sliding distance is determined according to a sliding indication and a verification answer is determined according to the verification target corresponding to the sliding distance; a verification result determined according to the verification question and the verification answer is uploaded; and the verification result returned from the server is received. If the verification is passed, normal login can be performed to display a corresponding search or query result page; and if the verification fails, the verification can be performed again.

Taking the comment verification scenario as an example, the user can enter corresponding comment data and click a submit control to submit the comment data, and then a corresponding serve side can return verification information, wherein the verification information comprises a verification question corresponding to a verification target; the verification question is displayed on a comment verification page; a sliding distance is determined according to a sliding indication and a verification answer is determined according to the verification target corresponding to the sliding distance; a verification result determined according to the verification question and the verification answer is uploaded; and the verification result returned from the server is received. If the verification is passed, the comment data can be submitted and a prompt message of successful comment can be received; and if the verification fails, the verification can be performed again.

Taking the transaction verification scenario as an example, the user can enter a transaction page to place an order, an order submission request is generated, and then verification information returned from a server according to the order submission request is received, wherein the verification information comprises a verification question corresponding to a verification target; the verification question is displayed on a transaction verification page; a sliding distance is determined according to a sliding indication and a verification answer is determined according to the verification target corresponding to the sliding distance; a verification result determined according to the verification question and the verification answer is uploaded; and the verification result returned from the server is received. If the verification is passed, the order can be submitted normally and after the order is submitted successfully, page data of transaction-related operations such as payment can be received; and if the verification fails, the verification can be performed again.

Taking the payment verification scenario as an example, the user can perform payment on a payment page, a payment submission request is generated according to the payment operation, and then verification information returned from a server according to the payment submission request is received, wherein the verification information comprises a verification question corresponding to a verification target; the verification question is displayed on a payment verification page; a sliding distance is determined according to a sliding indication and a verification answer is determined according to the verification target corresponding to the sliding distance; a verification result determined according to the verification question and the verification answer is uploaded; and the verification result returned from the server is received. If the verification is passed, payment data can be submitted normally for payment and after the payment is successful, it is possible to receive a payment result and go back to a corresponding transaction page, or display page data of other operations corresponding to the payment; and if the verification fails, the verification can be performed again.

In the above-described scenarios, taking a picture being the verification target as an example:

for the device: the verification question is displayed on a page, and the verification picture can be displayed with the execution of sliding so that the verification answer can be determined based on a part of the verification picture displayed by the sliding.

Therefore, a corresponding sub-picture in the verification picture can be displayed according to the sliding distance. Here, a slider bar can be displayed and the verification picture can be hidden under the slider bar, wherein the slider bar comprises a slider; and a position on the slider bar passed by the slider is determined, and the corresponding sub-picture in the verification picture is displayed at the position. Alternatively, a slider bar is displayed and the verification picture corresponding to the slider bar is hidden, wherein the slider bar comprises a slider; and a sliding distance of the slider on the slider bar is determined, and the corresponding sub-picture in the verification picture is displayed according to the sliding distance. Further, the verification picture can be displayed and a slider bar can be displayed correspondingly, wherein the slider bar comprises a slider.

The verification information further comprises target identifiers of the sub-picture in the verification picture; and the method further comprises downloading the sub-picture according to the target identifiers and forming the verification picture according to the sub-picture.

The verification information further comprises target identifiers of the sub-picture and a part of the sub-picture in the verification picture; and the method further comprises downloading, according to a sliding indication, a next sub-picture to be displayed. Therefore, the sub-pictures displayed later can be requested with the execution of the sliding, which further improves security and accuracy.

A verification answer is determined according to the verification picture corresponding to the sliding distance, which comprises determining, according to the sliding distance, a sequence set of the target identifiers of the sub-picture in the verification picture; and determining, according to the sequence set of the target identifiers, the verification answer.

For the server, each picture can be acquired from a picture library. Acquiring the verification picture and the verification question comprises at least one of the following: determining the verification question, determining a target picture according to content of the verification question, and determining the verification picture according to the target picture; and acquiring the target picture, determining the verification picture according to the target picture, and determining the verification question according to content of the verification picture. Here, the verification target is determined according to the target picture, which comprises acquiring an interference picture; and combining the target picture and the interference picture to generate the verification picture.

The verification picture and the verification question are used as verification information, which comprises: determining a sub-picture corresponding to the verification picture and target identifiers of the sub-picture, wherein the sub-picture is obtained by segmenting the verification picture, or the sub-picture comprises a target picture and an interference picture; and determining the target identifiers corresponding to the sub-picture and using the target identifiers and the verification question as the verification information.

The verification-based operations performed on the device and the server in the above-described scenarios are similar to those in the above-described embodiments, so reference may be made to the above-described embodiments for the corresponding operation steps, which will not be elaborated herein.

In the embodiments of the present disclosure, a corresponding verification question can be acquired according to a user’s requirement, and according to the thing described in the verification question, a corresponding target object of the thing and an interference object existing as a confusing item can be combined as a verification target. For security reasons, the verification target may not be directly returned to the device for display, and the picture may be segmented. The device downloads the picture according to the target identifiers of the sub-target information and displays it. The display process is displayed in sequence with the change of the position of the slider, so the sub-target information in the area that the slider does not reach will not be displayed. If the user thinks that the question is answered, he/she can release the slider, and correspondingly the sliding trajectory and other data can be reported to the server which comprehensively analyzes and determines the user’s trajectory, answer to the question, operating environment, and other information to conclude whether it is a machine operation and complete the verification of human and machine operations.

In the embodiments of the present disclosure, the picture and the question correspond to each other based on the content contained therein, so the question can be determined first and then the target object can be acquired, or the target object can be determined first and then the question can be determined, enabling more flexible setting of the verification question and the verification target.

The verification target displayed on the server can be a complete picture composed of multiple pieces of sub-target information, or the verification target can be segmented into multiple pieces of sub-target information and displayed in segments so that the verification target can be displayed more flexibly and the verification target can be gradually displayed according to the execution of sliding, which makes it difficult for a machine to analyze the answer and difficult to perform verification through machine operation, thereby improving verification accuracy.

The sub-target information in the verification target can be downloaded at one time or in batches, such as downloaded with the execution of sliding so that the device has at least a next piece of sub-target information to be displayed when the verification target is not fully displayed, further increasing the threshold of machine operation and the verification accuracy.

The sequence of the sub-target information in the verification target can be calculated on the device so that the answer can be dynamically changed to improve the verification accuracy.

In the conventional techniques, sometimes a verification question and pictures are provided to let the user click the picture required by the question, but in this way, each picture is completely displayed and the picture corresponding to the question is determined by clicking, making it easier to determine the picture corresponding to the question through static analysis and also easier to be simulated by a machine. However, in the embodiments of the present disclosure, the verification target is gradually displayed by sliding, and the sliding is stopped when the requirement of the question is met so that the verification can be performed more accurately, and the display of the verification target is more flexible. After the page is loaded, it is still difficult to statically analyze the answer corresponding to the verification question, and the end position of the sliding can be reached only when the condition corresponding to the verification question is met, which is very difficult to crack.

It should be noted that with regard to the method embodiments, in order to provide a concise description, the method embodiments are all expressed as a series of action combinations. Those skilled in the art, however, should know that the embodiments of the present disclosure are not limited by the described sequence of actions as some steps may be executed in another sequence or simultaneously according to the embodiments of the present disclosure. Secondly, those skilled in the art should also know that the embodiments described in the specification are all example embodiments, and the involved actions are not necessarily required by the embodiments of the present disclosure.

On the basis of the above-described embodiments, this embodiment further provides a verification apparatus, which is applied to electronic devices such as a terminal device.

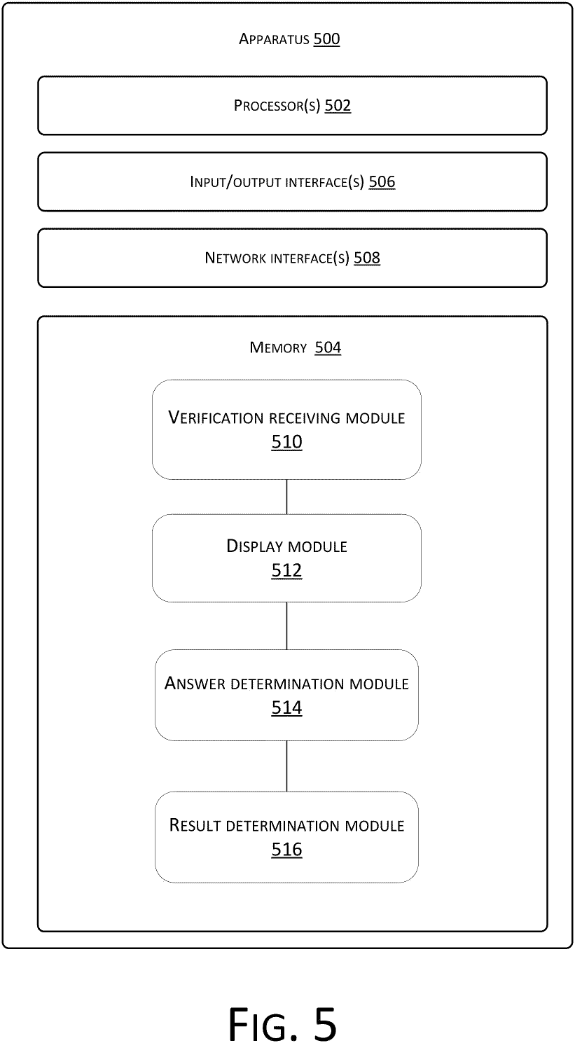

Referring to FIG. 5, a structural block diagram of a verification apparatus embodiment of the present disclosure is shown. In FIG. 5, an apparatus 500 includes one or more processor(s) 502 or data processing unit(s) and memory 504. The apparatus 500 may further include one or more input/output interface(s) 506 and one or more network interface(s) 508. The memory 504 is an example of computer-readable media.

Computer-readable media further include non-volatile and volatile, removable and nonremovable media employing any method or technique to achieve information storage. The information may be computer-readable instructions, data structures, modules of programs, or other data. Examples of computer storage media include, but are not limited to, a phase-change random access memory (PRAM), a static random access memory (SRAM), a dynamic random access memory (DRAM), other types of random access memories (RAM), a read-only memory (ROM), an electrically erasable programmable read-only memory (EEPROM), a flash memory or other memory technologies, a compact disc read-only memory (CD-ROM), a digital versatile disc (DVD) or other optical memories, a magnetic cassette tape, a magnetic tape, a magnetic disk storage or other magnetic storage devices, or any other non-transmission medium, which may be used to store information that can be accessed by a computing device. As defined herein, the computer-readable media do not include transitory media, such as modulated data signals and carriers.

The memory 504 may store therein a plurality of modules or units including the following:

A verification receiving module 510, configured to receive verification information returned according to a verification request, wherein the verification information comprises a verification question corresponding to a verification target.

A display module 512, configured to display the verification question.

An answer determination module 514, configured to determine a sliding distance according to a sliding indication and determine a verification answer according to the verification target corresponding to the sliding distance.

A result determination module 516, configured to determine a verification result according to the verification question and the verification answer.

To sum up, verification information returned according to a verification request is received, wherein the verification information comprises a verification question corresponding to a verification target; and then the verification question is displayed, and the verification target can be gradually displayed with a sliding distance determined according to a sliding indication so that the displayed part in the verification target can be determined according to the sliding distance, and after the sliding is completed, a verification answer is determined based on the end position of the sliding and a verification result is determined according to the verification question and the verification answer. In this way, since a picture is gradually displayed with a sliding operation, it is not only difficult to obtain the answer through static analysis but also difficult to be done through a machine operation, thus improving verification accuracy.

Here, the display module 512 is further configured to display, according to the sliding distance, corresponding sub-target information in the verification target.

The display module 512 is further configured to display a slider bar and hide the verification target under the slider bar, wherein the slider bar comprises a slider; and determine a position on the slider bar passed by the slider and display at the position the corresponding sub-target information in the verification target.

The display module 512 is further configured to display a slider bar and hide the verification target corresponding to the slider bar, wherein the slider bar comprises a slider; and determine a sliding distance of the slider on the slider bar and display, according to the sliding distance, the corresponding sub-target information in the verification target.

The display module 512 is further configured to display the verification target and display a slider bar correspondingly, wherein the slider bar comprises a slider.

The verification information further comprises target identifiers of the sub-target information in the verification target; and the answer determination module 514 is further configured to download the sub-target information according to the target identifiers and form the verification target according to the sub-target information.

The verification information further comprises target identifiers of the sub-target information and a part of the sub-target information in the verification target; and the answer determination module 514 is further configured to download, according to the sliding indication, a next piece of the sub-target information to be displayed.

The answer determination module 514 is configured to determine, according to the sliding distance, a sequence set of target identifiers of the displayed sub-target information in the verification target; and determine, according to the sequence set of the target identifiers, a verification answer.

The result determination module 516 is configured to form cross-verification information with the verification question and the verification answer, send the cross-verification information, and receive a verification result returned according to the cross-verification information.

The result determination module 516 is further configured to acquire sliding information corresponding to the sliding indication, wherein the sliding information comprises at least one of the following: stress information and speed information; and add the sliding information into the cross-verification information.

On the basis of the above-described embodiment, this embodiment further provides a verification apparatus, which is applied to electronic devices such as a server.

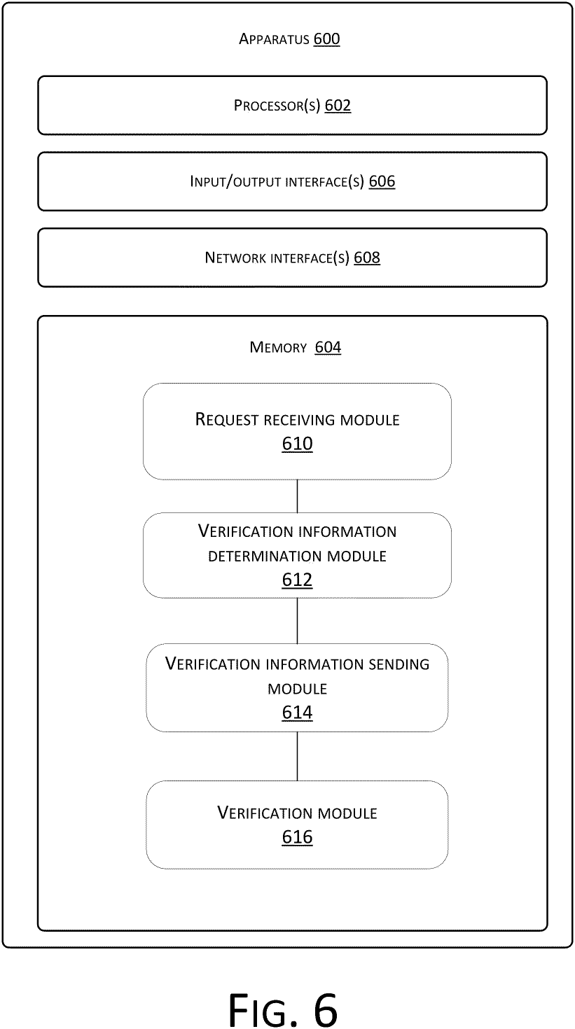

Referring to FIG. 6, a structural block diagram of a verification apparatus embodiment of the present disclosure is shown. In FIG. 6, an apparatus 600 includes one or more processor(s) 602 or data processing unit(s) and memory 604. The apparatus 600 may further include one or more input/output interface(s) 606 and one or more network interface(s) 608. The memory 604 is an example of computer-readable media.

The memory 604 may store therein a plurality of modules or units including the following:

A request receiving module 610, configured to receive a verification request.

A verification information determination module 612, configured to acquire a verification target and a verification question and use the verification target and the verification question as verification information.

A verification information sending module 614, configured to send the verification information to perform a verification operation according to the verification information and a sliding indication.

A verification module 616, configured to receive a verification answer and determine a verification result according to the verification question and the verification answer.

Here, the verification information determination module 612 is configured to determine a verification question, determine a target object according to content of the verification question, and determine a verification target according to the target object; and/or acquire the target object, determine the verification target according to the target object, and determine the verification question according to content of the verification target.

The verification information determination module 612 is configured to acquire an interference object; and combine the target object and the interference object to generate the verification target.

The verification information determination module 612 is configured to determine sub-target information corresponding to the verification target and target identifiers of the sub-target information, wherein the sub-target information is obtained by segmenting the verification target, or the sub-target information comprises a target object and an interference object; determine the target identifiers corresponding to the sub-target information; and use the target identifiers and the verification question as verification information.

The verification module 616 is configured to receive cross-verification information, wherein the cross-verification information comprises a verification question and a verification answer; and check whether the verification answer meets a condition corresponding to the verification question: if the condition corresponding to the verification question is met, generate the verification result of a pass; and if the condition corresponding to the verification question is not met, generate the verification result of a fail.

The cross-verification information further comprises sliding information, wherein the sliding information comprises at least one of the following: stress information and speed information; and the verification module 616 is further configured to determine, according to the sliding information, whether the corresponding sliding indication is a machine operation.

In the embodiments of the present disclosure, a corresponding verification question can be acquired according to a user’s requirement, and according to the thing described in the verification question, a corresponding target object of the thing and an interference object existing as a confusing item can be combined as a verification target. For security reasons, the verification target may not be directly returned to the device for display, and the picture may be segmented. The device downloads the picture according to the target identifiers of the sub-target information and displays it. The display process is displayed in sequence with the change of the position of the slider, so the sub-target information in the area that the slider does not reach will not be displayed. If the user thinks that the question is answered, he/she can release the slider, and correspondingly the sliding trajectory and other data can be reported to the server which comprehensively analyzes and determines the user’s trajectory, answer to the question, operating environment, and other information to conclude whether it is a machine operation and complete the verification of human and machine operations.

In the embodiments of the present disclosure, the picture and the question correspond to each other based on the content contained therein, so the question can be determined first and then the target object can be acquired, or the target object can be determined first and then the question can be determined, enabling more flexible setting of the verification question and the verification target.

The verification target displayed on the server can be a complete picture composed of multiple pieces of sub-target information, or the verification target can be segmented into multiple pieces of sub-target information and displayed in segments so that the verification target can be displayed more flexibly and the verification target can be gradually displayed according to the execution of sliding, which makes it difficult for a machine to analyze the answer and difficult to perform verification through machine operation, thereby improving verification accuracy.

The sub-target information in the verification target can be downloaded at one time or in batches, such as downloaded with the execution of sliding so that the device has at least a next piece of sub-target information to be displayed when the verification target is not fully displayed, further increasing the threshold of machine operation and the verification accuracy.

The sequence of the sub-target information in the verification target can be calculated on the device so that the answer can be dynamically changed to improve the verification accuracy.

In the conventional techniques, sometimes a verification question and pictures are provided to let the user click the picture required by the question, but in this way, each picture is completely displayed and the picture corresponding to the question is determined by clicking, making it easier to determine the picture corresponding to the question through static analysis and also easier to be simulated by a machine. However, in the embodiments of the present disclosure, the verification target is gradually displayed by sliding, and the sliding is stopped when the requirement of the question is met so that the verification can be performed more accurately, and the display of the verification target is more flexible. After the page is loaded, it is still difficult to statically analyze the answer corresponding to the verification question, and the end position of the sliding can be reached only when the condition corresponding to the verification question is met, which is very difficult to crack.

An embodiment of the present disclosure further provides a non-volatile readable storage medium on which one or more modules (programs) are stored, and applying the one or more modules on a device enables the device to execute instructions of each method step in the embodiments of the present disclosure.

An embodiment of the present disclosure provides one or more machine-readable media on which instructions are stored and when executed by one or more processors, cause an electronic device to perform one or more of the methods according to the above-described embodiments. In the embodiments of the present disclosure, the electronic device comprises various types of devices such as terminal devices and servers (clusters).

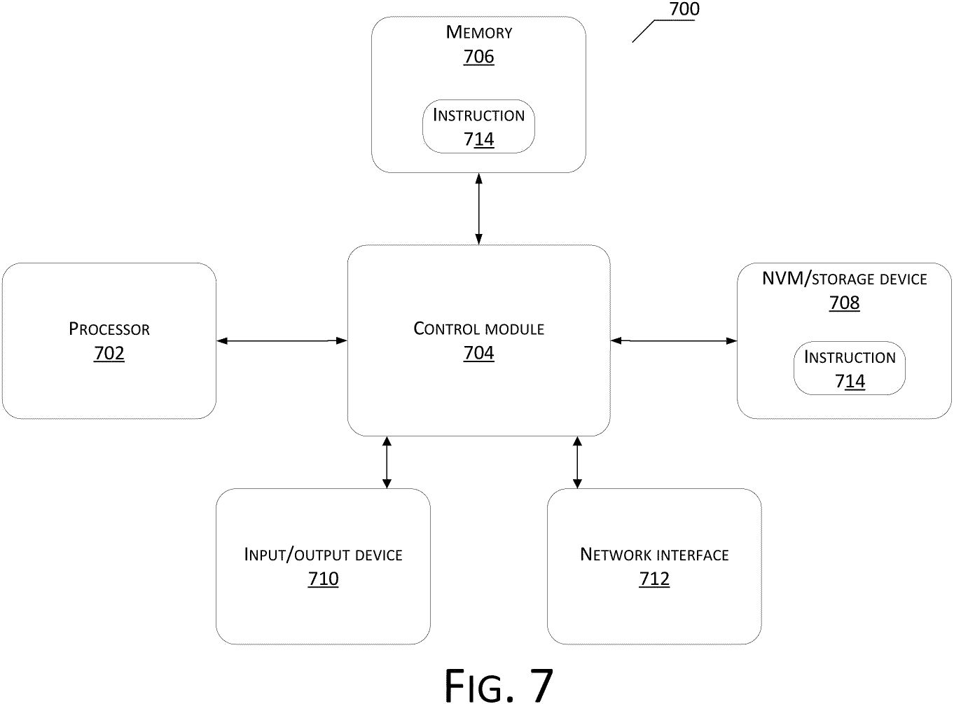

The embodiments of the present disclosure may be implemented as an apparatus that uses any suitable hardware, firmware, software, or any combination thereof to form a desired configuration, and the apparatus may comprise electronic devices such as terminal devices and servers (clusters). FIG. 7 schematically shows an example apparatus 700 that may be used to implement the embodiments described in the present disclosure.

In an embodiment, FIG. 7 shows an exemplary apparatus 700 having one or more processors 702, a control module (chipset) 704 coupled to at least one of the (one or more) processors 702, a memory 706 coupled to the control module 704, a non-volatile memory (NVM)/storage device 708 coupled to the control module 704, one or more input/output devices 710 coupled to the control module 704, and a network interface 712 coupled to the control module 704.

The processor 702 may include one or more single-core or multi-core processors, and the processor 702 may include any combination of general-purpose processors or dedicated processors (for example, a graphics processing unit, an application processor, a baseband processor, etc.). In some embodiments, the apparatus 700 can serve as a device such as the terminal device and the server (cluster) described in the embodiments of the present disclosure.

In some embodiments, the apparatus 700 may comprise one or more computer-readable media having instructions 714 (for example, the memory 706 or the NVM/storage device 708) and the one or more processors 702 compatible with the one or more computer-readable media and configured to execute the instructions 714 to implement modules and accordingly perform the actions described in the present disclosure.

For an example embodiment, the control module 704 may comprise any suitable interface controller to provide any suitable interface to at least one of the (one or more) processors 702 and/or any suitable device or component communicating with the control module 704.

The control module 704 may comprise a memory controller module to provide an interface to the memory 706. The memory controller module may be a hardware module, a software module, and/or a firmware module.

The memory 706 may be configured to, for example, load and store data and/or instructions 714 for the apparatus 700. In an embodiment, the memory 706 may comprise any suitable volatile memory, for example, a suitable DRAM. In some embodiments, the memory 706 may comprise a double-data-rate fourth generation synchronous dynamic random-access memory (DDR4SDRAM).

In an embodiment, the control module 704 may comprise one or more input/output controllers to provide an interface to the NVM/storage device 708 and the (one or more) input/output devices 710.

For example, the NVM/storage device 708 may be configured to store data and/or instructions 714. The NVM/storage device 708 may comprise any suitable non-volatile memory (for example, flash memory) and/or may comprise any suitable (one or more) non-volatile storage apparatuses (for example, one or more hard disk drives (HDDs), one or more compact disc (CD) drives, and/or one or more digital versatile disc (DVD) drives).

The NVM/storage device 708 may comprise storage resources that are physically part of the device on which the apparatus 700 is installed, or may be accessible by the device without necessarily being part of the device. For example, the NVM/storage device 708 may be accessed by the (one or more) input/output devices 710 via a network.

The (one or more) input/output devices 710 may provide an interface to the apparatus 700 to communicate with any other suitable device. The input/output devices 710 may comprise a communication component, audio component, sensor component, and the like. The network interface 712 may provide an interface to the apparatus 700 to communicate via one or more networks, and the apparatus 700 may perform wireless communication with one or more components in a wireless network according to any of one or more wireless network standards and/or protocols, for example, by accessing a communication standard-based wireless network, such as Wi-Fi, 2G, 3G, 4G, and 5G, or a combination thereof to perform wireless communication.

In an embodiment, at least one of the (one or more) processors 702 may be packaged with the logic of one or more controllers (for example, memory controller modules) of the control module 704. In an embodiment, at least one of the (one or more) processors 702 may be packaged with the logic of one or more controllers of the control module 704 to form a system-in-package (SiP). In an embodiment, at least one of the (one or more) processors 702 may be integrated with the logic of one or more controllers of the control module 704 on the same mold. In an embodiment, at least one of the (one or more) processors 702 may be integrated with the logic of one or more controllers of the control module 704 on the same mold to form a system-on-chip (SoC).

In various embodiments, the apparatus 700 may be, but is not limited to, a server, desktop computing device, or mobile computing device (for example, a laptop computing device, a handheld computing device, a tablet computer, a netbook, and the like). In various embodiments, the apparatus 700 may have more or fewer components and/or different architectures. For example, in some embodiments, the apparatus 700 comprises one or more cameras, keyboards, liquid crystal display (LCD) screens (comprising touch screen displays), non-volatile memory ports, multiple antennas, graphics chips, application-specific integrated circuits (ASIC), and speakers.

Here, main control chips can be used as processors or control modules in a detection apparatus, sensor data, location information, and the like are stored in a memory or NVM/storage device, sensor groups can be used as input/output devices, and communication interfaces may comprise network interfaces.

Since the apparatus embodiments are basically similar to the method embodiments, they are described in a more concise manner. For relevant content, reference may be made to the description of the method embodiments.

The various embodiments in this specification are described in a progressive manner, and each embodiment focuses on the differences from other embodiments. Reference may be made to each other for the same and similar parts among the various embodiments.

The embodiments of the present disclosure are described with reference to the flow charts and/or block diagrams of methods, terminal devices (systems), and computer program products according to the embodiments of the present disclosure. It should be understood that computer program instructions may be used to implement each process and/or each block in the flow charts and/or the block diagrams and a combination of processes and/or blocks in the flow charts and/or the block diagrams. These computer program instructions may be provided for a general-purpose computer, a dedicated computer, an embedded processor, or a processor of another terminal programmable data processing device to generate a machine so that the instructions executed by a computer or a processor of another terminal programmable data processing device generate an apparatus for implementing a specific function in one or more processes in the flowcharts and/or in one or more blocks in the block diagrams.

These computer program instructions may also be stored in a computer-readable memory that can instruct a computer or another terminal programmable data processing device to work in a specific manner so that the instructions stored in the computer-readable memory generate an artifact that includes an instruction apparatus. The instruction apparatus implements a specific function in one or more processes in the flow charts and/or in one or more blocks in the block diagrams.

These computer program instructions may also be loaded onto a computer or another terminal programmable data processing device, so that a series of operation steps are performed on the computer or another terminal programmable data processing device to generate computer-implemented processing. Therefore, the instructions executed on the computer or another terminal programmable data processing device are used to provide steps for implementing a specific function in one or more processes in the flowcharts and/or in one or more blocks in the block diagrams.

Although the example embodiments of the present disclosure have been described, those skilled in the art may make additional changes and modifications to these embodiments once they know the basic inventive concepts. Therefore, the appended claims are intended to be construed to comprise the example embodiments as well as all changes and modifications that fall within the scope of the embodiments of the present disclosure.

Finally, it should be noted that relational terms herein, such as first and second, are only used to distinguish one entity or operation from another entity or operation, and do not necessarily require or imply any such actual relationship or order among these entities or operations. Moreover, the term “include,” “comprise,” or any other variant thereof is intended to encompass non-exclusive inclusion, so that a process, method, product, or terminal device that involves a series of elements comprises not only those elements, but also other elements not explicitly listed, or elements that are inherent to such a process, method, product, or terminal device. Unless more limitations are stated, an element defined by the phrase “including a ...” does not exclude the existence of another identical element in the process, method, product, or terminal device that includes the element.

A verification method and apparatus, an electronic device, and a storage medium provided by the present disclosure have been described above in detail. The principles and implementation manners of the present disclosure are described with specific examples herein. The description of the embodiments is only used to help understand the method of the present disclosure and its core spirit; meanwhile, for those of ordinary skill in the art, according to the spirit of the present disclosure, changes may be made to the implementation manners and the application scope thereof. In summary, the content of this specification should not be construed as limiting the present disclosure.

The present disclosure may further be understood with clauses as follows.
Clause 1. A verification method, comprising:
   receiving verification information returned according to a verification request, wherein the verification information comprises a verification question corresponding to a verification target;
   displaying the verification question;
   determining a sliding distance according to the sliding indication and determining a verification answer according to the verification target corresponding to the sliding distance; and
   determining a verification result according to the verification question and the verification answer.
Clause 2. The method according to clause 1, further comprising:
   displaying, according to the sliding distance, corresponding sub-target information in the verification target.
Clause 3. The method according to clause 2, further comprising:
   displaying a slider bar and hiding the verification target under the slider bar, wherein the slider bar comprises a slider; and
   determining a position on the slider bar passed by the slider and displaying at the position the corresponding sub-target information in the verification target.
Clause 4. The method according to clause 2, further comprising:
   displaying a slider bar and hiding the verification target corresponding to the slider bar, wherein the slider bar comprises a slider; and
   determining the sliding distance of the slider on the slider bar and displaying, according to the sliding distance, the corresponding sub-target information in the verification target.
Clause 5. The method according to clause 2, further comprising:
   displaying the verification target and displaying a slider bar correspondingly, wherein the slider bar comprises a slider.
Clause 6. The method according to clause 1, wherein the verification information further comprises target identifiers of sub-target information in the verification target; and the method further comprises:
   downloading the sub-target information according to the target identifiers and forming the verification target according to the sub-target information.
Clause 7. The method according to clause 1, wherein the verification information further comprises target identifiers of sub-target information and a part of the sub-target information in the verification target; and the method further comprises:
   downloading, according to the sliding indication, a next piece of the sub-target information to be displayed.
Clause 8. The method according to clause 6 or 7, wherein the determining the verification answer according to the verification target corresponding to the sliding distance comprises:
   determining, according to the sliding distance, a sequence set of the target identifiers of the sub-target information displayed in the verification target; and
   determining, according to the sequence set of the target identifiers, the verification answer.
Clause 9. The method according to clause 1, wherein determining the verification result according to the verification question and the verification answer comprises:
   forming cross-verification information with the verification question and the verification answer and sending the cross-verification information; and
   receiving the verification result returned according to the cross-verification information.
Clause 10. The method according to clause 9, further comprising:
   acquiring sliding information corresponding to the sliding indication, wherein the sliding information comprises at least one of the following: stress information and speed information; and
   adding the sliding information into the cross-verification information.
Clause 11. The method according to any one of clauses 1-10, wherein the verification target comprises at least one of the following: pictures, texts, numbers, and symbols.
Clause 12. A verification method, comprising:
   receiving a verification request;
   acquiring a verification target and a verification question and using the verification target and the verification question as verification information;
   sending the verification information to perform a verification operation according to the verification information and a sliding indication; and
   receiving a verification answer and determining a verification result according to the verification question and the verification answer.
Clause 13. The method according to clause 12, wherein the acquiring the verification target and the verification question comprises at least one of the following:
   determining the verification question, determining a target object according to content of the verification question, and determining the verification target according to the target object; and
   acquiring the target object, determining the verification target according to the target object, and determining the verification question according to content of the verification target.
Clause 14. The method according to clause 13, wherein the determining the verification target according to the target object comprises:
   acquiring an interference object; and
   combing the target object and the interference object to generate the verification target.
Clause 15. The method according to clause 12, wherein the using the verification target and the verification question as the verification information comprises:
   determining sub-target information corresponding to the verification target and target identifiers of the sub-target information, wherein the sub-target information is obtained by segmenting the verification target, or the sub-target information comprises a target object and an interference object; and
   determining the target identifiers corresponding to the sub-target information and using the target identifiers and the verification question as the verification information.
Clause 16. The method according to clause 12, wherein the receiving the verification answer and determining the verification result according to the verification question and the verification answer comprises:
   receiving cross-verification information, wherein the cross-verification information comprises the verification question and the verification answer;
   checking whether the verification answer meets a condition corresponding to the verification question;
   if the condition corresponding to the verification question is met, generating the verification result of a pass; and
   if the condition corresponding to the verification question is not met, generating the verification result of a failure.
Clause 17. The method according to clause 16, wherein the cross-verification information further comprises sliding information which comprises at least one of the following: stress information and speed information; and after determining that the condition corresponding to the verification question is met, the method further comprises:
   determining, according to the sliding information, whether the corresponding sliding indication is a machine operation.
Clause 18. The method according to any one of clauses 12-17, wherein the verification target comprises at least one of the following: pictures, texts, numbers, and symbols.
Clause 19. A verification apparatus, comprising:
   a verification receiving module, configured to receive verification information returned according to a verification request, wherein the verification information comprises a verification question corresponding to a verification target;
   a display module, configured to display the verification question;
   an answer determination module, configured to determine a sliding distance according to a sliding indication and determine a verification answer according to the verification target corresponding to the sliding distance; and
   a result determination module, configured to determine a verification result according to the verification question and the verification answer.
Clause 20. A verification apparatus, comprising:
   a request receiving module, configured to receive a verification request;
   a verification information determination module, configured to acquire a verification target and a verification question and use the verification target and the verification question as verification information;
   a verification information sending module, configured to send the verification information to perform a verification operation according to the verification information and a sliding indication; and
   a verification module, configured to receive a verification answer and determine a verification result according to the verification question and the verification answer.
Clause 21. An electronic device, comprising: a processor; and
   a memory having an executable code stored therein, wherein when the executable code is executed, the processor is caused to execute the method according to one or more of clauses 1-11.
Clause 22. One or more machine-readable media having an executable code stored thereon, wherein when the executable code is executed, a processor is caused to execute the method according to one or more of clauses 1-11.
Clause 23. An electronic device, comprising: a processor; and
   a memory having an executable code stored therein, wherein when the executable code is executed, the processor is caused to execute the method according to one or more of clauses 12-18.
Clause 24. One or more machine-readable media having an executable code stored thereon, wherein when the executable code is executed, a processor is caused to execute the method according to one or more of clauses 12-18.

What is claimed is:

1. A method comprising:
receiving verification information returned according to a verification request, the verification information including a verification question corresponding to a verification target;
displaying the verification question;
determining a sliding distance according to a sliding indication;
determining a verification answer corresponding to the sliding distance; and
determining a verification result according to the verification question and the verification answer.

2. The method according to claim 1, wherein the determining the verification answer corresponding to the sliding distance comprises:
displaying, according to the sliding distance, corresponding sub-target information in the verification target.

3. The method according to claim 2, wherein the displaying, according to the sliding distance, the corresponding sub-target information in the verification target comprises:
displaying a slider bar, the slider bar including a slider;
hiding the verification target;
determining a position on the slider bar passed by the slider; and
displaying at the position the corresponding sub-target information in the verification target.

4. The method according to claim 2, wherein the displaying, according to the sliding distance, the corresponding sub-target information in the verification target comprises:
displaying a slider bar, the slider bar including a slider;
hiding the verification target;
determining the sliding distance of the slider on the slider bar; and
displaying, according to the sliding distance, the corresponding sub-target information in the verification target.

5. The method according to claim 2, wherein:
the verification information further includes target identifiers of the sub-target information in the verification target; and
the method further comprises:
downloading the sub-target information according to the target identifiers; and
forming the verification target according to the sub-target information.

6. The method according to claim 1, wherein:
the verification information further includes sub-target information in the verification target and target identifiers of the sub-target information; and
the method further comprises:
downloading, according to the sliding indication, next piece of sub-target information to be displayed.

7. The method according to claim 1, further comprising:
displaying the verification target; and
displaying a slider bar, the slider bar including a slider.

8. The method according to claim 1, wherein the determining the verification answer corresponding to the sliding distance comprises:
determining, according to the sliding distance, a sequence set of target identifiers of sub-target information displayed in the verification target; and
determining, according to the sequence set of the target identifiers, the verification answer.

9. The method according to claim 1, wherein the determining the verification result according to the verification question and the verification answer comprises:
forming cross-verification information with the verification question and the verification answer;
sending the cross-verification information; and
receiving the verification result returned according to the cross-verification information.

10. The method according to claim 9, further comprising:
acquiring sliding information corresponding to the sliding indication, the sliding information including at least one of following: stress information and speed information; and
adding the sliding information into the cross-verification information.

11. The method according to claim 1, wherein the verification target comprises at least one of following:
a picture;
a text;
a number; and
a symbol.

12. An apparatus comprising:
one or more processors; and
one or more memories storing thereon computer-readable instructions that, when executed by the one or more processors, cause the one or more processors to perform acts comprising:
receiving a verification request;
acquiring a verification target and a verification question;
determining verification information according to the verification target and the verification question;
sending the verification information to perform a verification operation according to the verification information and a sliding indication;
receiving a verification answer; and
determining a verification result according to the verification question and the verification answer.

13. The apparatus according to claim 12, wherein the acquiring the verification target and the verification question comprises:
determining the verification question;
determining a target object according to a content of the verification question; and
determining the verification target according to the target object.

14. The apparatus according to claim 13, wherein the determining the verification target according to the target object comprises:
acquiring an interference object; and
combing the target object and the interference object to generate the verification target.

15. The apparatus according to claim 12, wherein the acquiring the verification target and the verification question comprises:
acquiring a target object;
determining the verification target according to the target object; and
determining the verification question according to a content of the verification target.

16. The apparatus according to claim 12, wherein the determining the verification information according to the verification target and the verification question comprises:
determining sub-target information corresponding to the verification target and target identifiers of the sub-target information, wherein the sub-target information is obtained by segmenting the verification target, or the sub-target information includes a target object and an interference object;
determining the target identifiers corresponding to the sub-target information; and
using the target identifiers and the verification question as the verification information.

17. The apparatus according to claim 12, wherein the determining a verification result according to the verification question and the verification answer comprises:
receiving cross-verification information, the cross-verification information including the verification question and the verification answer;
determining that the verification answer meets a condition corresponding to the verification question;
generating a verification result of pass.

18. The apparatus according to claim 12, wherein the determining a verification result according to the verification question and the verification answer comprises:
receiving cross-verification information, the cross-verification information including the verification question and the verification answer;
determining that the verification answer does not meet a condition corresponding to the verification question;
generating a verification result of fail.

19. The apparatus according to claim 18, wherein:
the cross-verification information further comprises sliding information, the slide information including at least one of following: stress information and speed information; and
the determining that the verification answer does not meet the condition corresponding to the verification question includes:
determining, according to the sliding information, that the sliding indication is a machine operation.

20. One or more memories storing thereon computer-readable instructions that, when executed by one or more processors, cause the one or more processors to perform acts comprising:
receiving verification information returned according to a verification request, the verification information including a verification question corresponding to a verification target;
displaying the verification question;
determining a sliding distance according to a received sliding indication;
determining a verification answer according to the verification target corresponding to the sliding distance; and
determining a verification result according to the verification question and the verification answer.
